(19) United States
(12) Patent Application Publication
(10) Pub. No.: US 2011/0281082 A1
(43) Pub. Date: Nov. 17, 2011

(54) COVERED COMPOSITE LATTICE SUPPORT STRUCTURES AND METHODS ASSOCIATED THEREWITH

(75) Inventor: Erich A. Wilson, Provo, UT (US)

(73) Assignee: Sigma-Tek, L.L.C., Provo, UT (US)

(21) Appl. No.: 13/108,873

(22) Filed: May 16, 2011

Related U.S. Application Data
(60) Provisional application No. 61/334,931, filed on May 14, 2010.

(51) Int. Cl. B32B 3/12; B29C 70/30

(52) U.S. Cl. 428/178; 156/293

(57) ABSTRACT

Three-dimensional carbon fiber based composite support structures and methods for the manufacture and use thereof are disclosed and described. In one aspect, such a support structure may include a lattice of intersecting support members made of a carbon fiber composite material and a cover of the same carbon fiber composite material as the lattice, fused to at least one side of the lattice and covering at least a portion thereof.

### RELATED APPLICATIONS

This application claims the benefit of U.S. Provisional Application Ser. No. 61/334,931, filed May 14, 2010, and entitled, “Covered Composite Lattice Support Structures and Methods Associated Therewith,” which application is incorporated by reference herein in its entirety.

### FIELD OF THE INVENTION

The present invention relates to composite lattice support structures. Accordingly, the present invention involves the fields of chemistry, materials science, and engineering technology.

### BACKGROUND OF THE INVENTION

Composite lattice support structures have been developed because of the high strength to weight ratios that they can provide. Lower weight almost always provides a commercial advantage if strength can remain at least the same. Reductions in shipping cost, construction cost, and cost of handling and use, are almost always certain when weight is reduced. Moreover, performance values of most products increase as weight is decreased. Automobiles, aircraft, sporting goods, and numerous other products can perform at higher rates and with greater efficiency when weight is minimized.

### SUMMARY OF THE INVENTION

While lattice support structures provide many weight reduction advantages, for many products, the open and broken nature of lattice designs creates presents other drawbacks. First, the lattice appearance is often considered less aesthetically pleasing as compared to a well finished solid surface appearance. Second, for many products, particularly those that are handled during use such as a tennis racquet, golf club, or the like, a lattice structure can impede performance and even pose safety issues as compared to a device with a solid contact surface. Further, exposure to the interior of a lattice structure may present a drawback for industrial products that are used in an outdoor environment. Cell phone towers, windmill posts, wind turbine poles, or other construction supports may experience undesirable issues with wildlife and vegetation, and also with traveling debris and dirt when lattice designs are used. Exposed lattice designs also are more difficult to clean and maintain than solid surface designs. Finally, many products which are meant to act as a container or a transport, such as a pipe or storage unit (i.e. box), must have a solid surface exterior rather than a lattice in order to retain their contents.

Accordingly, the present invention provides three-dimensional carbon fiber based composite support structures. In one embodiment, such a structure may include a three-dimensional lattice of intersecting support members made of a carbon fiber composite material. The lattice may generally have opposing sides and a cover of the same carbon fiber composite material as the lattice fused to at least one side of the lattice and covering at least a portion thereof.

The present invention further provides methods for the making or fabrication of three-dimensional covered carbon fiber based composite support structures. In one embodiment, such a method may include: 1) forming a lattice of intersecting support members made of a carbon fiber composite material which has opposing sides; and 2) fusing a cover of the same carbon fiber composite material as the lattice to at least one side of the three-dimensional lattice structure.

In addition, the present invention includes a method of improving the bend strength of a three-dimensional carbon fiber based composite lattice structure. In one aspect, such a method may include fusing to at least one side of the lattice, in a manner that improves the bend strength thereof, a cover of carbon fiber based composite material that is the same as the carbon fiber based composite material of the lattice.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side view of a covered carbon fiber based composite support structure in accordance with one aspect of the invention.

FIG. 2 is a perspective view of a covered carbon fiber based composite support structure that is made by a two step process in accordance with the present invention.

FIG. 3 is a perspective view of a covered carbon fiber based composite support structure that is made by a one step process in accordance with the present invention.

FIG. 4 is a flow diagram depicting the basic elements of both a 1-step method and a 2-step method for the production of a covered carbon fiber based composite support structure in accordance with one embodiment of the present invention.

FIG. 5 is an exploded cross-section view of a mandrel having a plurality of channels engaged with fiber composite materials for the formation of a lattice and an overlaid cover of the same fiber composite material in accordance with one embodiment of the present invention.

FIG. 6 is a cross-sectional view of a collapsible mandrel having fiber composite materials engaged in the grooves of the working surface thereof and a cover of fiber composite material wrapped around the working surface thereof in accordance with one embodiment of the present invention.

FIG. 7a-7d show graphical results of testing data obtained from testing the devices of the present invention.

### DETAILED DESCRIPTION OF THE INVENTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “the cross member” includes one or more of such cross members, and reference to “a carbon based composite material” includes reference to one or more of such materials.

### DEFINITIONS

In describing and claiming the present invention, the following terminology will be used in accordance with the definitions set forth below.

As used herein, “fiber-based composite material” refers to a material comprised of carbon or other fiber (e.g., a carbon or glass fiber filament) and resin (e.g., polymer matrix) constituents.

As used herein “preform” refers to a green, uncured composite lay-up comprising the fiber material and resin composite as situated in grooves on a mandrel or other suitable mold, and that has undergone preliminary shaping but is not yet in its final consolidated or cured form.

As used herein, “working surface” refers to an exterior surface of a mold that is used in three dimensions to form, engage, sculpt, mold, hold, direct, guide, etc., a fiber-based composite material to be consolidated into an article. Such working surface may have grooves or other technical or functional features formed therein and use of the term working surface refers to surfaces inside the grooves or other designs or features as well as those surfaces outside. Alternatively, such working surface may be unbroken and/or substantially smooth.

As used herein a “multi-layered” node, refers to cross supports in a lattice that are not merely stacked on top of one another, but rather, where a first individual cross support has multiple layers with one or more layer(s) of material from other cross supports there between. Thus, in order to be “multi-layered,” there must be at least one cross support or layer of at least one cross support that is between at least two layers of another cross support where at least one of them protrudes from the three standard Cartesian planes in a curved or other fashion as seen from standard Cartesian Coordinates. Typically, however, each cross support of the node is layered with other cross support layers there between. The term “multi-layered” node may also be described as one or more selective individual fiber filaments of one cross support intersecting and being layered with one or more individual selective fiber filaments of at least one other cross support.

As used herein, the term “three dimensional” refers to a shape having at least one point with positive or negative X, Y, and Z values in a Cartesian Coordinate System.

As used herein, the terms “lattice” and “lattice structure” refer to a three dimensional structure consisting of members crossing each other to create nodes in an isogrid fashion.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Invention

The present invention provides methods and systems for forming covered composite lattice support structures. Examples of carbon fiber based composite support structures and articles as well as methods and equipment for the fabrication thereof, can be found in U.S. patent application Ser. Nos. 12/542,442, 12/542,555, 12/542,613, 12/542,607, and 61/234,553, each filed Aug. 17, 2009, as well as 61/265,246 filed Nov. 30, 2009, each of which is incorporated herein by reference.

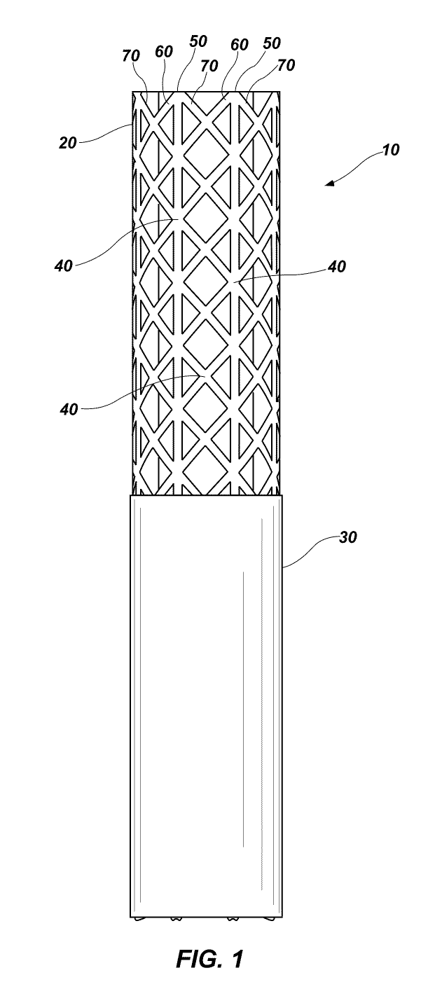

Referring now to FIG. 1, is shown a three-dimensional carbon fiber based composite support structure 10 in accordance with one embodiment of the present invention. The support structure has a three-dimensional lattice of intersecting support members 20 made of a carbon fiber composite material. A cover 30 of the same carbon fiber composite material as the lattice is fused to at least one side of the lattice and covers at least a portion thereof. As the lattice has opposing sides, the cover can be fused to one side of the lattice, or both sides of the lattice. Furthermore, the cover may cover substantially the entire lattice, or may cover only a portion of the lattice.

The intersecting support members of the lattice intersect at a junctions known as nodes 40 that may in some aspects of the invention be multilayered. In other aspects, the nodes may be single layered or substantially single layered. A variety of specific support member types may be included in the lattice such as longitudinal support members 50, helical support members 60, reverse helical support members 70, transverse support members (not shown), and lateral support members (not shown). In some aspects of the invention each of these types of support members may be found in a single three-dimensional lattice. Additional support members of specific configurations and directional orientation may also be included as required in order to provide a device with specific characteristics or properties.

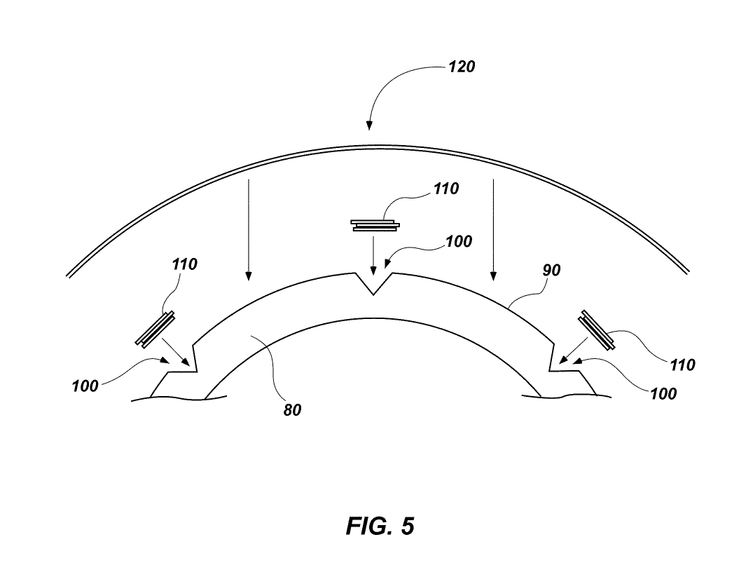

As shown in FIGS. 1 and 4, the lattice of the present invention is formed as a three dimensional article. In one embodiment of the invention, the three dimensional article may have a cross section with an open perimeter. In other aspects, a cross section with a closed perimeter may be used. Whether open or closed perimeter is used, the three dimensional articles of the present invention may take a variety of specific geometric shapes and sizes. Referring again to FIGS. 1 and 4, is shown a three dimensional article that is elongated about a longitudinal axis and has a cross sectional shape of a circle. However, a wide variety of other cross sectional shapes may be utilized as well in order to produce an article with specifically desired characteristics. Such cross sectional shapes include without limitation: circular, square, rectangle, triangle, octagonal, star, pentagonal, hexagonal, airfoil, or crescent shapes among others. In one aspect, the shape is a circle. In another the shape is a square.

Moreover in some embodiments, the longitudinal axis of the article may include more than one (i.e. two or more) cross sectional shape. For example, in one aspect, a portion of the article may have a circular cross section and a second portion may have an oval cross section. In yet another example, the longitudinal axis of the article may include three or four different cross sectional shapes. In a further embodiment of the invention, two or more cross sectional shapes may be used with each shape applied in multiple segments. For example one cross sectional arrangement may be circular transitioning to oval transitioning back to circular. In yet another example, the cross sectional arrangement may be circular transitioning to oval transitioning to square.

In yet additional embodiments the cross sectional shape of the three dimensional article may be irregular, or specifically shaped to match that of a shape to which the three dimensional article is to become engaged. For example, in one aspect of the invention, the lattice of the present invention may be meant to slidably engage and cover a 2×4 piece of wood for building construction. In such a case, the lattice would have an open perimeter with an opening along one side and would have a cross sectional shape substantially matching the shape of the wooden 2×4 and a size that is slightly larger than the wooden 2×4, so as to allow the article to engage the 2×4 in a snug fit and be fixed into place.

In an additional aspect of the invention, the three dimensional article may not have an elongated longitudinal axis, but may be a cube or sphere or pyramid or cone or other geometry that is not elongated in shape. Again, such shapes may be of nearly any size or dimension required to provide a product with a specifically desired characteristic or function. Further, such shapes may have an open or closed perimeter depending on the end use and result desired.

Referring again to FIG. 1, the cover 30 fused to the three-dimensional lattice 20 may be of substantially the same, or of exactly the same principle materials as the materials of the lattice. However, in some aspects, the materials may be different from those of the lattice, or may at least differ in concentration or amount. The material(s) of the cover, particularly if different from those of the lattice, can be configured to be compatible with the carbon fiber composite material in that it is capable of fusing to the carbon fiber composite material of the lattice. Further, in some aspects of the invention, the materials for the carbon fiber composite lattice and the cover may be selected to complement one another or to facilitate ease of production etc. For example, in one aspect, the cover materials may have a melting point that is slightly below, or otherwise below, the melting point of the lattice materials in order to allow the cover to fuse to the lattice without substantial deformation of the lattice during heat processing as noted in the two step formation process articulated below.

As described in further detail below, the extent to which the cover is fused to the lattice may be controlled and may be selected in order to provide an article or product with specifically desired performance characteristics. In one aspect, the cover may be fused to substantially every support member in the lattice. In another aspect, the cover can be fused to substantially ever node in the lattice. In yet a further aspect, the cover member can be fused to substantially ever support member and node in the lattice. In additional certain aspects, the cover can be fused between portions of the support members which face one another. When this occurs, the cover will have a dimpled outer surface with recesses showing the effective location of the support members of the lattice. The cover will contact and wrap around the perimeter of each support member in an amount of between about 30% to about 90% of the perimeter and the cover will effectively extend between portions of the support members otherwise facing each other. In some aspects, the extent of perimeter contact and fusing between the cover and each individual support member perimeter may be from about 30% to about 70%. In other aspects the contact and fusing may be from about 30% to about 50%. In some aspects, the amount of contact and fusing may be the same and in other aspects, the amount of fusing may be less than the amount of contact.

Alternatively, as discussed below in the discussion of an article made by a one step process, the outer surface of the cover 30 may be smooth or substantially smooth. In some aspects, lines a least loosely identifying the locations of the support members may be visible. In this case, the lines will be indentations in the outer surface of the cover. In such cases, the extent of perimeter contact and fusing between the cover and each individual support member perimeter may be from about 10% to about 55%. In another aspect, the contact and fusing may be from about 10% to about 40%. In yet another aspect, the contact and fusing may be from about 5% to about 30%.

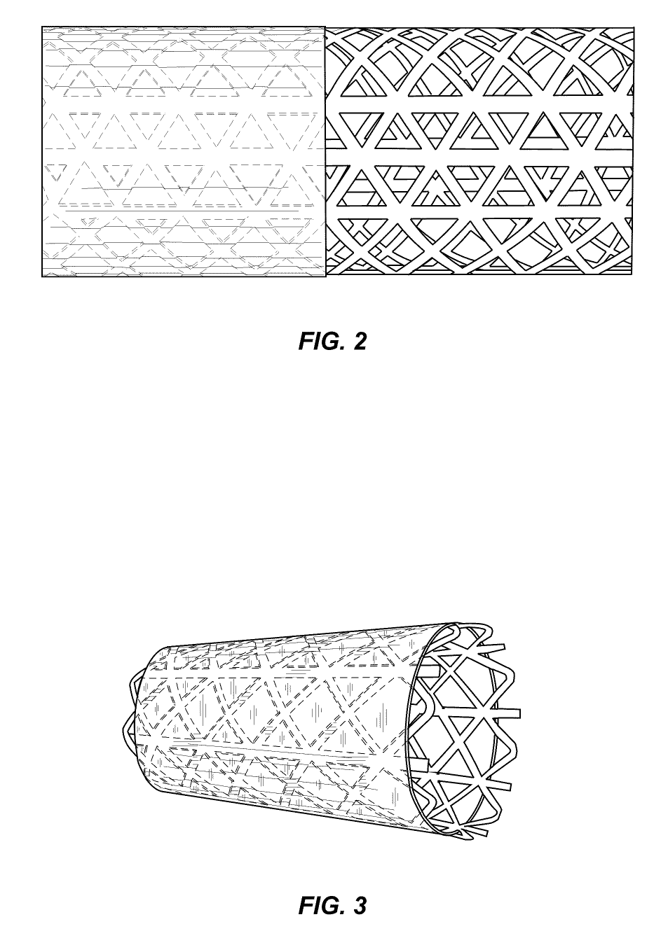

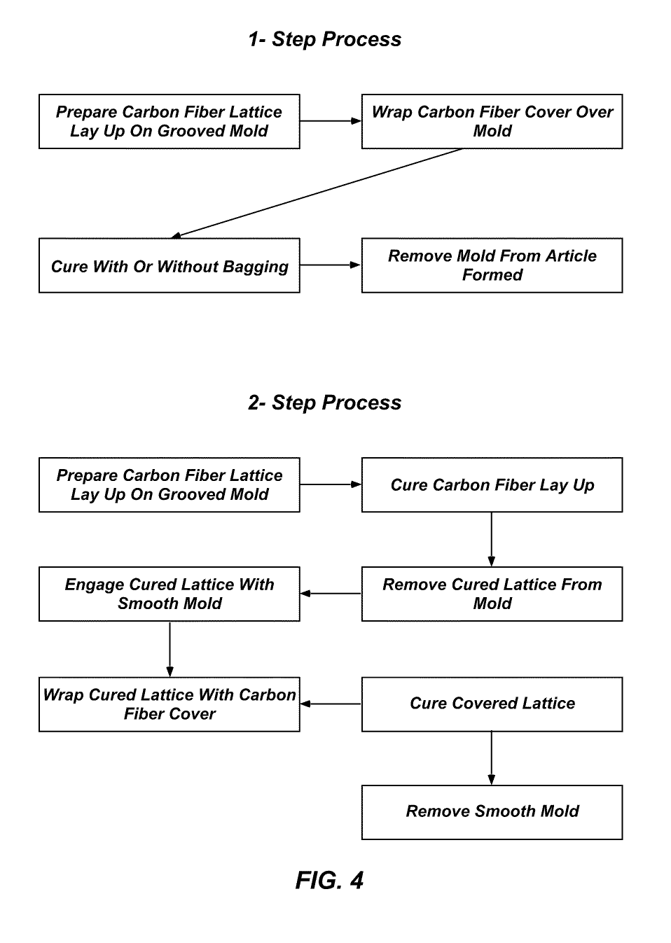

Hence, when a two step process for fabricating three dimensional articles is used, the cover recesses or dimples at the spaces between the support members as shown in FIG. 2 and when a one step process is used, then the cover recesses, slight though they may be, will occur on top of or at the support members as shown in FIG. 3.

The thickness of the support members of the lattice and of the cover may be any thickness required in order to provide an article with specifically desired characteristics and performance properties. However, in one aspect, the cover may have a thickness that is less than the thickness of the support members. In another aspect, the thickness of the cover may be less than about three quarters of the thickness of the support members. In a further aspect, the cover thickness may be less than about half of the thickness of the support members. In a further aspect, the cover thickness may be less than about one third of the thickness of the support members. In yet a further aspect, the thickness of the cover may be less than about one quarter of the thickness of the support members. In another aspect the thickness of the cover and the support members may be about equal. In another aspect, the thickness of the cover may be greater than the thickness of the support members.

In addition to the devices and articles disclosed and described herein, the present invention further encompasses methods for making such devices and articles. At a fundamental level, such a method can include forming a lattice of intersecting support members made of carbon fiber composite material, and fusing a cover of the same, or substantially the same, carbon fiber composite material to at least one side of the lattice.

Referring now to FIG. 4 is shown a flow diagram generally outlining the steps for making a covered carbon fiber based composite support structure in either a one step process or a two step process in accordance with the present invention. In a one step process, a carbon composite lattice is formed by providing a grooved mold and engaging a carbon fiber lay up into the grooves of the mold. Next, the outer surface of the mold is covered or wrapped with sheets of carbon fiber or a carbon fiber composite material. This assembly of mold, carbon fiber composite material engaged in the grooves of the mold, and carbon fiber or carbon fiber composite material sheets covering the mold, is then processed or cured, under certain temperature and pressure conditions. During the curing process, the carbon fiber sheets become pressed against the exposed surface of the carbon fiber composite material contained within the grooves on the mold. As the carbon fiber material of the sheets and within the grooves cures, the material in the grooves form a solid lattice and the material of the sheets form a solid cover that is fused to the lattice. The mold is then removed from the article.

In a two step process, a lattice of carbon fiber material is produced using the same general activities of the one step process, except that no carbon fiber or carbon fiber composite material sheets are used to cover the mold. Once the cured carbon fiber lattice is produced and released from the grooved mold, it is engage with a smooth mold on one side, and sheets of carbon fiber or carbon fiber composite material are overlaid or wrapped on the opposing side. This assembly of smooth mold, cured lattice, and uncured carbon fiber sheets or wrap is then cured. During the curing process, the pressure conditions presses the carbon fiber sheets along the lattice and at least partially down into the spaces between the lattice and against the surface of the smooth mold. The carbon fiber sheets are then fused to the lattice and solidified. Once cured, the smooth mold is removed from the article now produced.

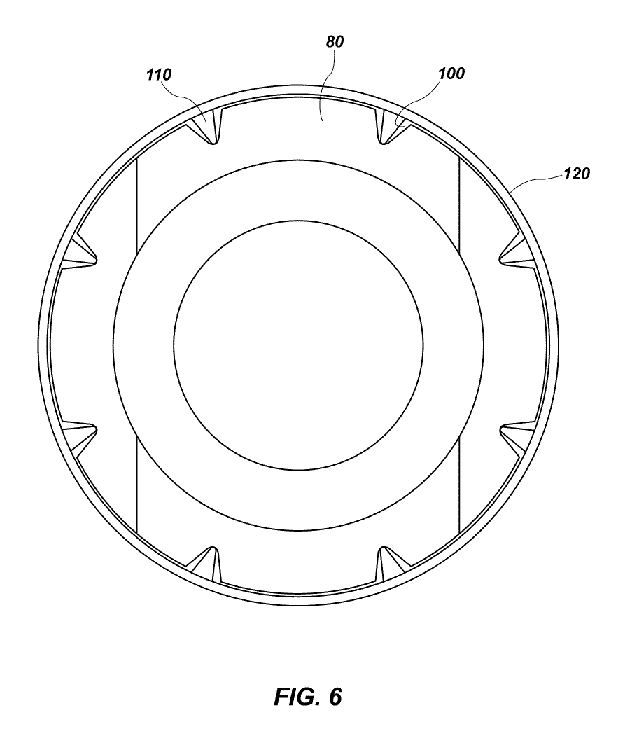

Referring now to FIG. 5 is shown a cross section of a mold assembly being performed in order to carry out either a one step process for making the articles of the present invention, or the first portion of a two step process for making the articles of the present invention. As can be seen, a rigid mold 80 is provided having a working surface 90 with a network of channels 100. The network of channels intersects at strategic locations forming nodes. The channels further cooperatively establish a substantially continuous interconnected lattice corresponding to a geometric configuration to be imparted to a composite lattice support structure. In one aspect, the rigid mold may be a collapsible mandrel. Additional details and examples of collapsible mandrels useful in the present invention may be found in the patent applications incorporated herein by reference.

Once the aforementioned mold is provided, carbon fiber material 110 in the presence of a resin is deposited into the channels 100. To provide a carbon fiber material lay-up that is systematically arranged to contribute to the make-up of a plurality of composite cross supports that intersect to firm a plurality of nodes. Once thusly prepared, the mold assembly may be cured in order to consolidate the fiber material within the channels in the present of heat and pressure. In some aspects, the pressure can be concentrated about the channels to enhance compaction of the fiber material within the channels. Additional details and examples of various specific methods for forming a carbon fiber composite lattice as recited herein may be found in the above-recited patent applications that have been incorporated herein by reference.

If a one step process is being used, then following deposit of the carbon composite fiber material lay up 110 into the grooves or channels 100 on the rigid mold 80, a sheet or plurality of sheets of a carbon fiber composite material 120 are used to cover the rigid mold holding the carbon fiber material within the mold channels. Once the carbon fiber sheets are applied, curing proceeds as previously described. In one aspect of the present invention, a dynamic pressure transfer layer (not shown) can be applied about the mold assembly (i.e. rigid grooved mold filled with composite carbon fiber lay-up material and overlaid with the carbon fiber sheets). The pressure transfer layer is typically resilient and adapted to displace about the working surface of the mold assembly and concentrate and applied pressure about the working surface and channels and onto said fiber material lay-up to compact the carbon fiber material on the working surface of the mold and within the channels. In this way, the carbon fiber sheets are pressed against the carbon fiber lay-up in the mold channels and become fused thereto during the curing process to form a covered article in accordance with the present invention. Additional details on the use of the dynamic pressure transfer layer can again be found in those cases incorporated herein by reference.

In a two step process, the step of fusing the cover to the lattice happens in a second step and the lattice only is formed in the first step. Once the lattice is formed, the second step of fusing the cover follows. In one aspect of the present invention, the cured lattice can be secured to an unbroken or smooth, resilient surface. Such a surface will typically have a shape corresponding to the shape into which the lattice was formed during the first step of the process. The lattice is then covered with the carbon fiber sheets much like in the one step process and the dynamic pressure transfer layer is then applied about the covered lattice. The assembly is then cured using heat and pressure to fuse the carbon fiber sheets to the carbon fiber lattice. Once curing is complete, the assembly, including the smooth resilient surface or mold, and dynamic pressure transfer layer are removed from the cured article.

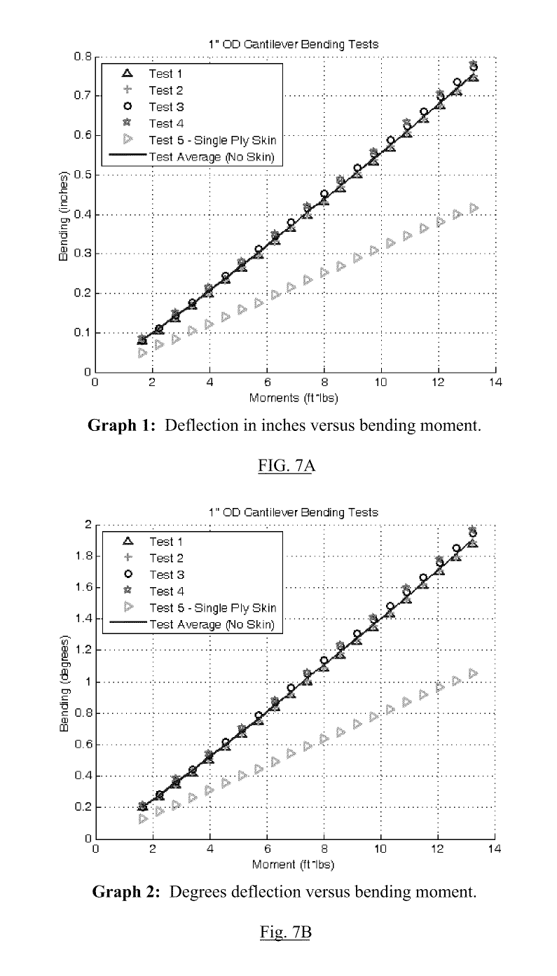

It is to be noted that the covered lattice may be formed into a three dimensional shape, as previously recited, either in situ during the one step or two step processes described herein. In such an embodiment, the rigid mold device will have a shape substantially matching that of a desired geometric configuration for the article being produced. For example, referring to FIG. 6, is shown a mold assembly using a mold 80, with a circular shaped cross section. The shape and size of the mold is imparted to the carbon fiber composite material lattice 110 in the grooves 100 and eventually also to the carbon fiber cover 120.

The geometric shape of the article may also be imparted in an ex-situ step. If a one step process has been used, then the entire covered lattice would be shaped using a suitably shaped mold and adequate heat and pressure conditions to reshape the covered lattice into a desired three dimensional configuration. If a two step process is used, then the lattice may be shaped in a step subsequent to its formation and curing, but either before or after application of the carbon fiber cover. In such cases, geometric shapes with both open and closed perimeter cross sections may be formed.

The Applicant has discovered certain advantages associated with the covered support structures of the present invention. In addition to improved aesthetic look and feel, ability to handle and touch the support structure, and the prevention of dirt and debris from entering the interior space of such structure, the Applicant has discovered that the bend strength of a covered composite article in accordance with the present invention is unexpectedly improved as compared to an uncovered or exposed lattice of the same material, thickness, configuration, and dimension.

Accordingly, in one aspect of the invention, a method of improving or increasing bend strength of a carbon fiber composite lattice structure is also encompassed by the present invention. In one aspect, such a method may include fusing to at least one side of the lattice a cover of carbon fiber composite material as recited herein. As previously noted, the carbon fiber material cover can be substantially the same as that of the lattice, or can be somewhat different. Further, its thickness and coverage of the lattice may also vary as noted herein. In some aspects, the cover may increase the bend strength by a factor that is greater than a factor of weight added to the lattice by the cover. Moreover, in some aspects, the bend strength may be improved by a factor that is greater than the weight added by the cover, while the torsional strength does not improve by a factor that is greater than a factor of weight added to the lattice by the cover. In a further aspect of the invention, the bend strength may increase by a factor of from about 1 to about 6. In yet another aspect, the bend strength increase may be more than a factor of about 2. In a further aspect, the increase may be by a factor of more than about 4. In a further aspect, the increase may be by a factor of greater than about 5. In yet another aspect, the increase may be by a factor of greater than about 10 or more. In another aspect, the bend strength increase may be proportional to the weight increase or to the thickness of the cover. In some aspects, the cover thickness may be used to control bend strength increase.

### EXAMPLES

### Example 1

A collapsible mandrel of approximately 4 inches diameter and an exterior surface having grooves of approximately 0.130″ depth and forming a lattice was obtained. Carbon prepreg filaments were then wrapped into the grooves until they were substantially filled. A prepreg carbon fiber sheet of 8 feet×8 inches in dimension and 0.018″ in thickness was then wrapped around the working surface of the mandrel to cover it. The unit was then wrapped with FEP, a thin blue polymer sheet, to keep the resin from attaching to the bagging material. Once the FEP was taped in place, a layer of a polyurea coating was sprayed over the FEP layer until the tool was completely coated and airtight. Ports were then added to the ends and the airtight seal was validated. Once prepared in this fashion the tool was hooked up to a vacuum pump through the portals on the ends and placed into a hydroclave where the air pressure was raised to 90 psi and the temperature was maintained constant at 350° F. Once the hydroclave was closed, the cure cycle is comprised of a 45 minute saturation of the tool at temperature. Once cured, the tool was removed from the hydroclave the polyurea and FEP coatings were discarded. The mandrel was collapsed and the skinned lattice structure now resembling a tube was removed. As shown in FIG. 2, slight indentations may in some embodiments be present on the exterior surface of the cover. Such indents are generally in the pattern of the underlying lattice and result from the compression of the cover down into the channels or grooves on the mandrel which are filled with the carbon fiber lattice material since that material is softer than the other materials of the rigid mold. This is also evidence of the contact made between the cover and the lattice during the curing process. Once removed from the mandrel, the article may be prepared for post-processing wherein it may be sanded, blasted and/or coated as needed for the specific application it is intended.

### Example 2

In the two-step process, the three-dimensional lattice structure is prepared in the same fashion as recited above, but without a carbon fiber fabric coating. Once the lattice has been post-processed and it is determined that part or all of the unit need to have a skin added, then a smooth tube matching the internal diameter (when circular) or otherwise matching the internal space, of the lattice is inserted along that portion which will receive the skin coating. Prepreg fabric is then added by wrapping or covering the lattice. The unit is then processed completely once again as described above in the cure cycle. As shown in FIG. 3, in this embodiment, the cover generally becomes recessed between the lattice members. This is due to the opposite effect as the slight indentations resulting in Example 1. Namely, because the finished lattice is now raised up compared to the underlying smooth tube substrate on which it rests, the pressing action during curing presses the carbon fiber cover down in between the lattice members causing a recess into each space which carries through the curing process and into the finished article.

Testing

A variety of articles having differing specific size parameters were produced by either of the above-recited methods and tested. Cantilever bending tests were conducted for a 1 inch outer diameter unit, 22.75″ long wrapped in 4×4 T700 tow with a Longi-Heli count of 6×6 for a standard three-dimensional lattice structure tube and one unit covered with 1-ply skin 0.018″ thick. The resulting aspect ratio is Ar=22.75. The standard unit weighed 68.4 g (2.4127 oz) while the skinned unit weighed 114.5 g (4.0389 oz). At this small size a single ply of skin (0.018″ thick) increases the weight of the article by a factor of 1.67.

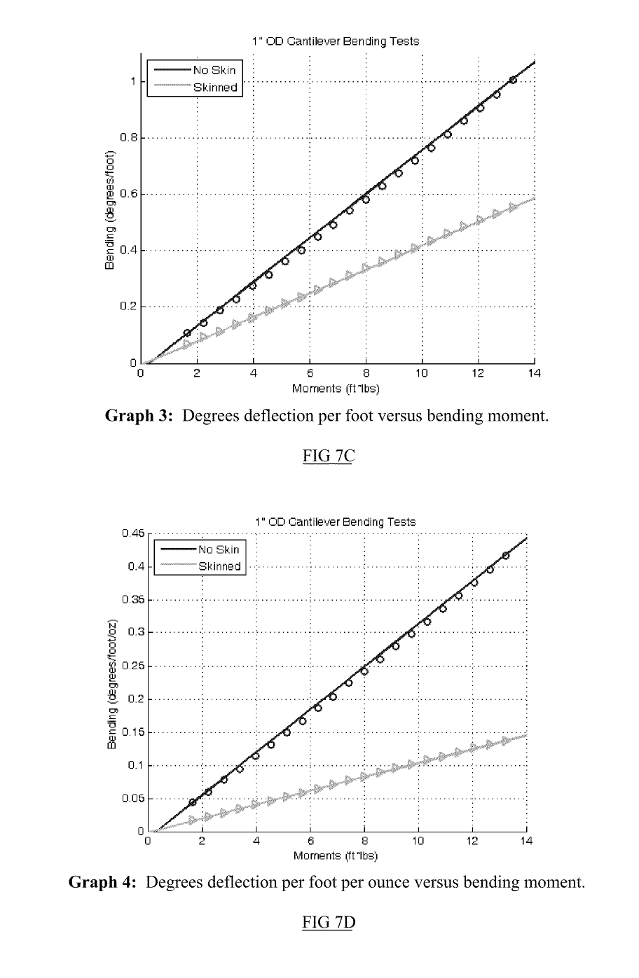

Graph 1 as shown in FIG. 7a demonstrates the data of four tests without a skin and a single test with a skin with the dependent variable of deflection in inches based on the applied moment measured in ft*lbs. Notably the data of the first four tests appear very linear with a small deviation. Graph 2 as shown in FIG. 7b shows the same data using degrees of deflection away from the standard axis as the dependent variable where the deviations are ε=±0.0015° at the lowest load and rising to a standard deviation of ε=±0.0376° at the highest load, where the deflection is 1.9033°. This results in a maximum deviation of data ε=±1.98%, well within standard empirical practices of ε=±5.00%. In this instance, the single data set for the covered article can then be taken as an average performance as well.

Graph 3 as shown in FIG. 7c shows the degrees deflection normalized by the length of the units to produce performances in (degrees/foot). Whereas the aspect ratio and overall geometry affect the weight of the article, FIG. 4 is further normalized by the mass of the units. The equations modeling specific performances of the units are:

δ=0.078M−0.025 (degrees) (1)

for a structure with no skin and

δ=0.0423M−0.0063 (degrees) (2)

for a structure with a single ply skin. While these equation define only the 1 inch diameter unit. Ignoring the constant in the equations, the ratio of the slopes gives a general comparison of the benefits achieved through skin addition. In this case, the skin adds strength by a factor of 1.84, slightly higher than the weight ratio. Thus, 10% bending strength was added for the same weight as increasing the tow wrap by 3 wraps to a 7×7.

In specific performance comparison of Graph 4 as shown in FIG. 7d shows, the advantage of the skin over the unskinned version is almost 3:1. This appears to coincide with the larger tested units which proved an improvement in bending strength of almost 4:1 with 2-plies of skin.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A carbon fiber based composite support structure, comprising:
a lattice of intersecting support members made of a carbon fiber composite material, said lattice having opposing sides and shaped into a three dimensional shape; and
a cover made of a material compatible with the carbon fiber composite material of the lattice, said cover fused to at least one side of the lattice and covering at least a portion thereof.

2. The support structure of claim 1, wherein each intersection of support members forms a node.

3. The support structure of claim 2, wherein the nodes are multilayered.

4. The support structure of claim 2, wherein the lattice includes at least two types of support members selected from the group consisting of: lateral support members, longitudinal support members, transverse support members, helical support members, and reverse helical support members.

5. The support structure of claim 4, wherein the lattice includes each type of support member.

6. The support structure of claim 1, wherein the three dimensional shape has a closed perimeter cross section.

7. The support structure of claim 1, wherein the three dimensional shape has an open perimeter cross section.

8. The support structure of claim 1, wherein the three dimensional shape is elongated about a longitudinal axis and has a cross sectional shape selected from the group consisting of a circle, a square, a rectangle, a triangle, an octagon, a star, a pentagon, a hexagon, an airfoil, a crescent, and any combination of these.

9. The support structure of claim 1, wherein the cover covers substantially the entire lattice.

10. The support structure of claim 1, wherein the cover is fused to both sides of the lattice.

11. The support structure of claim 1, wherein the cover is fused to substantially every support member in the lattice.

12. The support structure of claim 2, wherein the cover is fused to substantially every node in the lattice.

13. The support structure of claim 12, wherein the cover is fused to substantially every support member and node in the lattice.

14. The support structure of claim 1, wherein the cover is fused between portions of the support members which face one another.

15. The support structure of claim 1, wherein the cover has a substantially smooth exterior surface.

16. The support structure of claim 1, wherein the cover has recessed portions between the lattice members.

17. The support structure of claim 1, wherein the cover has a thickness that is less than a thickness of the support members.

18. The support structure of claim 1, wherein the material of the cover comprises the same carbon fiber composite material of the lattice.

19. A carbon fiber based composite support structure, comprising:
a lattice of intersecting support members made of a carbon fiber composite material, said lattice having opposing sides and shaped into a three dimensional shape; and
a cover made of a material compatible with the carbon fiber composite material of the lattice, said cover fused to at least one side of the lattice and covering at least a portion thereof,
wherein the cover increases the bend factor of the lattice by a factor of at least one.

20. A method of improving bend strength of a carbon fiber based composite lattice structure comprising:
forming a lattice structure of intersecting support members made of a carbon fiber composite material; and
fusing a cover to at least one side of the lattice structure in a manner that improves the bend strength thereof, wherein the cover comprises a material compatible with the carbon fiber composite material of the lattice structure.
